(19) United States
(12) Patent Application Publication
(10) Pub. No.: US 2014/0065422 A1
(43) Pub. Date: Mar. 6, 2014

(54) STRETCHABLE CONDUCTIVE NANOFIBERS AND METHODS OF PRODUCING THE SAME

(71) Applicants: INDUSTRY-UNIVERSITY COOPERATION FOUNDATION SOGANG UNIVERSITY, Seoul (KR); SAMSUNG ELECTRONICS CO., LTD., Suwon-si (KR)

(72) Inventors: Sang-won KIM, Seoul (KR); Jong-jin PARK, Hwaseong-si (KR); Bong-june SUNG, Seoul (KR); Kwan-woo SHIN, Seoul (KR)

(73) Assignees: INDUSTRY-UNIVERSITY COOPERATION FOUNDATION SOGANG UNIVERSITY, Seoul (KR); SAMSUNG ELECTRONICS CO., LTD., Suwon-si (KR)

(21) Appl. No.: 14/017,830

(22) Filed: Sep. 4, 2013

(30) Foreign Application Priority Data
Sep. 4, 2012 (KR) 10-2012-0097816

(51) Int. Cl. D01D 5/00; H01B 1/22; H01B 1/24

(52) U.S. Cl. CPC D01D 5/003; H01B 1/24; H01B 1/22
USPC 428/401; 252/500; 252/511; 252/512; 252/513; 252/514; 264/10

(57) ABSTRACT

A stretchable conductive nanofiber includes a polymer nanofiber, and one-dimensional conductive nanoparticles that form a percolation network within the polymer nanofiber, and are oriented at an angle in a range of about 0° to about 45° with a respect to an axis of the polymer nanofiber.

### CROSS-REFERENCE TO RELATED APPLICATION

This application claims priority from Korean Patent Application No. 10-2012-0097816, filed on Sep. 4, 2012, in the Korean Intellectual Property Office, the disclosure of which is incorporated herein in its entirety by reference.

### BACKGROUND

1. Field

The present disclosure relates to conductive nanofibers and methods of producing the same, and more particularly, to stretchable conductive nanofibers and methods of producing the stretchable conductive nanofibers.

2. Description of the Related Art

A fiber-based electronic device is still only a theoretical concept, but it is very likely to replace electronic devices currently available in the consumer marketplace because fiber has a number of advantages over traditional electronic devices, including its stretchability, wearability, large surface area, the availability of a variety of surface treatments, and the easy formation of a composite material including the fiber. Examples of fiber-based electronic devices include textile solar cells, transistors, stretchable displays, exterior-stimulated drug deliveries, biosensors and gas sensors, light-controlling functional textiles, functional clothing, defense industry functional products, and the like.

It may be advantageous to use a conductive nanofiber in a fiber-based electronic device to maintain conductivity and to secure a wide range of elongation. A related art electrode in the form of a composite of a matrix and a conductive material may need a large quantity of conductive material in order to obtain a desired conductivity. However, if the ratio of the conductive material to composite matrix is increased, although the conductivity may be improved, the composite may become less stretchable because the elasticity of the matrix may be reduced.

### SUMMARY

One or more embodiments provide stretchable conductive nanofibers that maintain conductivity during a strain process.

One or more embodiments also provide are methods of producing stretchable conductive nanofibers that maintain conductivity during a strain process.

According to an aspect of an embodiment, there is provided a stretchable conductive nanofiber including a polymer nanofiber, and one-dimensional conductive nanoparticles that form a percolation network within the polymer nanofiber and that are oriented at an angle in a range of from about 0° to about 45° with respect to an axis of the polymer nanofiber.

The polymer nanofiber may include polyurethane (PU), polyvinyl alcohol (PVA), polyethylene oxide (PEO), nylon, polyacrylonitrile (PAN), polydimethylsiloxane (PDMS), low-density polyethylene (LDPE), polymethyl methacrylate (PMMA), or a mixture thereof.

The polymer nanofiber may have a diameter in a range of from about 50 nm to about 1 μm.

The one-dimensional conductive nanoparticles may include a carbon-based material, an inorganic material, or a mixture thereof.

The carbon-based material may include a carbon nanotube or a carbon nanofiber. The carbon nanotube may include a single-walled carbon nanotube (SWNT), a double-walled carbon nanotube (DWNT) or a multi-walled carbon nanotube (MWNT).

The inorganic material may include a metal nanowire or a metal nanorod. The metal may be gold, platinum, silver, copper, tungsten, nickel, tin, zinc, molybdenum, or an alloy thereof.

The one-dimensional conductive nanoparticles may have a diameter in a range of from about 1 nm to about 100 nm. The one-dimensional conductive nanoparticles may have a length in a range of from about 100 nm to about 10,000 nm. The one-dimensional conductive nanoparticles may have an aspect ratio in a range of from about 10 to about 1,000. The one-dimensional conductive nanoparticles may be present in an amount of from about 0.1 to about 5 parts by weight based on 100 parts by weight of the entire stretchable conductive nanofiber.

According to an aspect of another embodiment, there is provided a method of producing a stretchable conductive nanofiber, the method including forming a composition by dissolving both one-dimensional conductive nanoparticles and a polymer in a solvent and electrospinning the composition so that the one-dimensional conductive nanoparticles form a percolation network within the polymer nanofiber, and are oriented at an angle in a range of from about 0° to about 45° with respect to an axis of the polymer nanofiber.

The solvent may include dimethylformaldehyde (DMF), tetrahydrofuran (THF), chloroform, chlorobenzene, toluene, dimethyl sulfoxide (DMSO), N-methylpyrrolidone (NMF), water, acetone, ethanol, or a mixture of two or more thereof.

### BRIEF DESCRIPTION OF THE DRAWINGS

These and/or other aspects will become apparent and more readily appreciated from the following description of embodiments, taken in conjunction with the accompanying drawings of which:

FIG. 1 is a perspective view conceptually illustrating a stretchable conductive nanofiber, according to an embodiment;

FIG. 2 is a flowchart illustrating a method of producing a stretchable conductive nanofiber, according to an embodiment;

FIG. 3 is a simulation snapshot of a stretchable conductive nanofiber in the case that one-dimensional conductive nanoparticles are distributed within a polymer matrix when the elongation rate is 0;

FIG. 4 is a simulation snapshot of a stretchable conductive nanofiber in the case that one-dimensional conductive nanoparticles are distributed within a polymer matrix when the elongation rate is 0.4;

FIG. 5 is a graph illustrating results obtained by simulating the ratio of electrical conductivity to the elongation rate of a polymer nanofiber in which one-dimensional conductive nanoparticles are distributed;

FIG. 6 is a graph illustrating results obtained by simulating the probability of a percolation network being maintained based on the elongation rate of a polymer nanofiber in which zero-dimensional conductive nanoparticles are distributed;

FIG. 7 is a graph illustrating results obtained by simulating the ratio of electrical conductivity to the elongation rate of a polymer nanofiber in which zero-dimensional conductive nanoparticles are distributed;

FIG. 8A is a scanning electron microscope (SEM) image of a polyurethane nanofiber including a multi-walled carbon nanotube, according to an embodiment;

FIG. 8B is a transmission electron microscopy (TEM) image of a polyurethane nanofiber including a multi-walled carbon nanotube, according to an embodiment;

FIG. 9 is a graph illustrating results obtained by measuring electrical conductivity based on the carbon nanotube content in a polyurethane nanofiber; and

FIG. 10 is a graph illustrating results obtained by measuring changes in the diameter of a nanofiber and in the electrical conductivity thereof based on the elongation rate of a polyurethane nanofiber that includes 0.1 wt % of carbon nanotubes.

### DETAILED DESCRIPTION

Reference will now be made in detail to embodiments, examples of which are illustrated in the accompanying drawings, wherein like reference numerals refer to like elements throughout. In this regard, the present embodiments may have different forms and should not be construed as being limited to the descriptions set forth herein. Accordingly, the embodiments are merely described below, by referring to the figures, to explain aspects of the present description.

The term “one-dimensional nanoparticle” in the present specification refers to a nanoparticle such as a nanorod, a nanowire, or a nanotube, having a length along one axis longer than a length in a perpendicular axis.

The term “zero-dimensional nanoparticle” in the present specification refers to a nanoparticle having similar lengths along all axes, such as a quantum dot.

The term “percolation network” in the present specification refers to a network structure wherein unit particles are randomly arranged but are interconnected.

The term “percolation threshold” in the present specification refers to the least number of particles necessary to form a percolation network.

The term “elongation rate” in the present specification refers to the ratio of the length after elongation to the length before elongation.

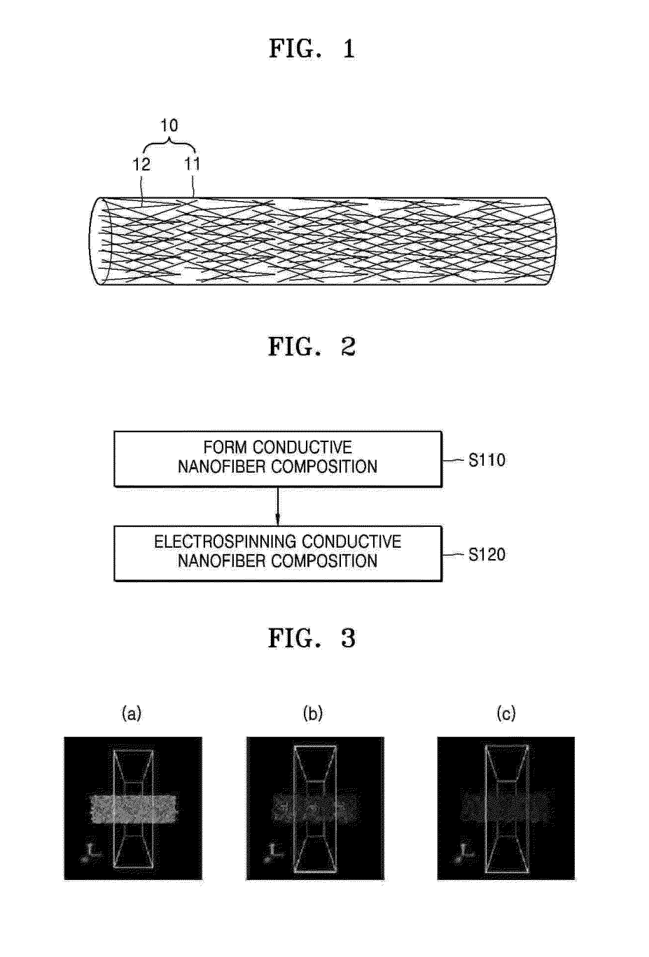

FIG. 1 is a perspective view conceptually illustrating a stretchable conductive nanofiber 10, according to an embodiment. Referring to FIG. 1, the stretchable conductive nanofiber 10 includes a polymer nanofiber 11 and one-dimensional conductive nanoparticles 12 within the polymer nanofiber 11. The one-dimensional conductive nanoparticles 12 may also be present on a surface of the polymer nanofiber 11. The one-dimensional conductive nanoparticles 12 form a percolation network. Accordingly, the stretchable conductive nanofiber 10 may have electrical conductivity.

The polymer nanofiber 11 may be a nanofiber composed of a polymer. For example, the polymer may include polyurethane (PU), polyvinyl alcohol (PVA), polyethylene oxide (PEO), nylon, polyacrylonitrile (PAN), polydimethylsiloxane (PDMS), low-density polyethylene (LDPE), polymethyl methacrylate (PMMA), or mixtures thereof but is not limited thereto.

The polymer nanofiber 11 may have a diameter in a range of from about 50 nm to 1 μm. When the polymer nanofiber 11 has a diameter in the above range, a percolation network may be formed to increase a ratio or amount of the one-dimensional conductive nanoparticles 12 within the polymer nanofiber 11 aligned in a lengthwise direction of the polymer nanofiber 11.

When the ratio of the one-dimensional conductive nanoparticles 12 that are aligned in the lengthwise direction of the polymer nanofiber 11 is increased, the amount of one-dimensional conductive nanoparticles 12 needed to obtain a given conductivity may be reduced. This is because a shorter electrical path may be formed if the conductive one-dimensional nanoparticles 12 are aligned in the lengthwise direction of the polymer nanofiber 11. Furthermore, as the amount of the one-dimensional conductive nanoparticles 12 within the polymer nanofiber 11 decreases, the elastic properties of the stretchable conductive nanofiber 10 may more closely resemble those of the polymer nanofiber 11, making the stretchable conductive nanofiber 10 more stretchable. In addition, as the amount of one-dimensional conductive nanoparticles 12 decreases, the transparency of the stretchable conductive nanofibers 10 may be improved.

The one-dimensional conductive nanoparticles 12 may be made from a carbon-based material, an inorganic material, or a mixture thereof. The carbon-based material may include a carbon nanotube or a carbon nanofiber. The carbon nanotube may be a single-walled carbon nanotube (SWNT), a double-walled carbon nanotube (DWNT), or a multi-walled carbon nanotube (MWNT). The carbon nanotube may have a functional group, such as a carboxyl group, a hydroxyl group, an acrylic group, an epoxy group or a fluorine group, or the like on a surface thereof.

The inorganic material may include a metal nanowire or a metal nanorod. Examples of the metal may include metals with high conductivity, such as gold, platinum, silver, copper, tungsten, nickel, tin, zinc, molybdenum, or an alloy thereof.

The one-dimensional conductive nanoparticles 12 each may have a diameter in the range of from about 1 nm to about 100 nm, and a length in the range of from about 100 nm to about 10,000 nm. The one-dimensional conductive nanoparticles 12 each may have an aspect ratio in the range of from about 10 to about 1,000. In addition to the dimensions above, the one-dimensional conductive nanoparticles 12 within the polymer nanofiber 11 may be oriented at an angle in a range of from about 0° to about 45° as measured against an axis of the polymer nanofiber 11. Accordingly, as described above, it is possible for a small amount of the one-dimensional conductive nanoparticles 12 to form a percolation network within the polymer nanofiber 11. Namely, the one-dimensional conductive nanoparticles 12 may have a low percolation threshold. The amount of the one-dimensional conductive nanoparticles 12 may be in the range of from about 0.1 to about 5 parts by weight based on 100 parts by weight of the stretchable conductive nanofiber 10.

In the case that the polymer nanofiber 11 is elongated according to an embodiment, the percolation network of the one-dimensional conductive nanoparticles 12 may be maintained, thus maintaining an electrical path. Accordingly, the stretchable conductive nanofiber 10 may maintain electrical conductivity and may be used in a stretchable electrode. The electrical conductivity by the percolation network may vary depending on an extent that the stretchable conductive nanofiber 10 is elongated. As a result, the stretchable conductive nanofiber 10 may be used in applications such as motion sensors, biocompatible sensors, or the like.

FIG. 2 is a flowchart illustrating a method of producing a stretchable conductive nanofiber.

Referring to FIG. 2, a stretchable conductive nanofiber composition is formed (S 110). The stretchable conductive nanofiber composition may be formed by dissolving both a polymer for forming a nanofiber and one-dimensional conductive nanoparticles in a solvent.

Examples of the polymer for forming a nanofiber include polyurethane (PU), polyvinyl alcohol (PVA), polyethylene oxide (PEO), nylon, polyacrylonitrile (PAN), polydimethysiloxane (PDMS), low-density polyethylene (LDPE), or polymethyl methacrylate (PMMA), but is not limited thereto. The polymer should exhibit excellent stretchability due to the elastic properties of the polymer chain.

The one-dimensional conductive nanoparticles are as described above and may include a carbon-based substance, an inorganic substance, or a mixture thereof. The carbon-based substance may include a carbon nanotube or a carbon nanofiber. The carbon nanotube may include a single-walled nanotube (SWNT), a double-walled nanotube (DWNT), or a multi-walled nanotube (MWNT). The inorganic substance may include a metal nanowire or a metal nanorod. The metal may include a highly conductive metal such as gold, platinum, silver, copper, tungsten, nickel, tin, zinc, molybdenum or an alloy thereof. The one-dimensional conductive nanoparticles each may have a diameter in a range of from about 1 nm to about 100 nm, and a length in a range of from about 0.1 μm to about 10 μm. In addition, the one-dimensional conductive nanoparticles each may have an aspect ratio in the range of from about 10 to about 1,000. The one-dimensional conductive nanoparticles may be present in an amount in a range of from about 0.1 to about 5 parts by weight based on 100 parts by weight of the total of the composition.

Depending on a type and characteristics of the polymer, the solvent may include dimethylformaldehyde (DMF), tetrahydrofuran (THF), chloroform, chlorobenzene, toluene, dimethyl sulfoxide (DMSO), N-methylpyrrolidone (NMF), water, acetone, ethanol, or a mixture of two or more thereof, but is not limited thereto.

Referring again to FIG. 2, by using the conductive nanofiber composition, a stretchable conductive nanofiber may be formed by electrospinning (S120). In the stretchable conductive nanofiber, the one-dimensional conductive nanoparticles within the polymer nanofiber may form a percolation network. A diameter of the stretchable conductive nanofiber may be adjusted depending on a molecular weight of the polymer, type of solvent, an applied voltage, a spinning distance, a spinning temperature, a spinning humidity, or the like. In addition, by using the conductive nanofiber composition, the stretchable conductive nanofiber may be formed by using either a wet spinning process, a complex spinning process, a melt-blown spinning process, or a flash spinning process.

By adjusting the diameter of the polymer nanofiber within the range of from about 50 nm to about 1 μm, the one-dimensional conductive nanoparticles may be oriented at an angle in the range of from about 0° to about 45° as measured against an axis of the polymer nanofiber, to form a percolation network. As a result, the percolation threshold of the one-dimensional conductive nanoparticles may be reduced, and the stretchable conductive nanofiber may become more stretchable.

### EXAMPLE 1

The formation of a percolation network and electrical conductivity were predicted by a Monte Carlo simulation of the behavior of conductive particles within a polymer matrix (nanofiber). Spherical particles with 1σ in diameter were set in the simulation. It was assumed that 16 spherical particles (beads) were connected for each polymer chain, and bonding potential between the beads, intermolecular potential, and bending potential, or the like were considered. The one-dimensional conductive nanoparticles were assumed to have 1σ in diameter and 16σ in length. In addition, it was assumed that a cube simulation box with sides 35σ in length containing the one-dimensional conductive nanoparticles were infinitely repeated.

It was considered that electrical conductivity was present when the particles were connected, but that no electrical conductivity was present when the particles were separated from each other. It was also considered that a cluster was formed when the particles were connected. A cluster was classified as either a cluster that forms a percolation network or a cluster that does not form a percolation network. It was considered that a cluster that was connected from one end to the other end of the simulation box formed a percolation network whereas a cluster that was not connected to both ends formed no percolation network. Electrical conductivity was determined by the amount of clusters forming a percolation network.

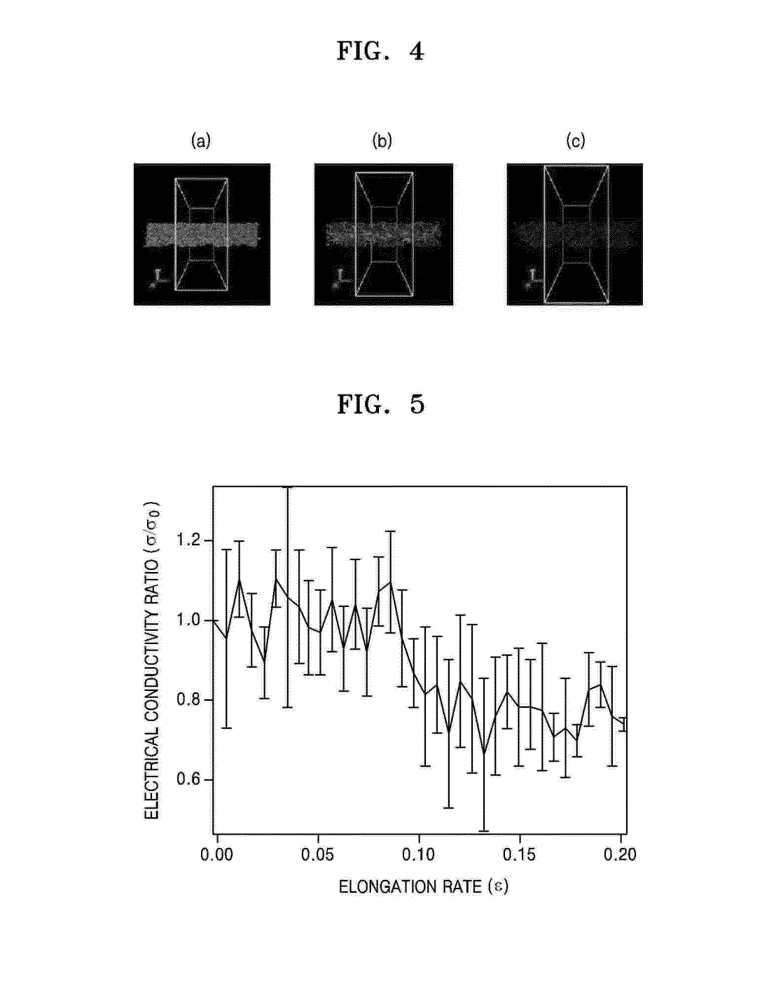

FIG. 3 is a simulation snapshot of a stretchable conductive nanofiber in the case where one-dimensional conductive nanoparticles are distributed within a polymer matrix when the elongation rate is 0, and FIG. 4 is a simulation snapshot of a stretchable conductive nanofiber in the case where one-dimensional conductive nanoparticles are distributed within a polymer matrix when the elongation rate is 0.4. In FIGS. 3 and 4, respective simulation snapshots (a) show whole nanoparticles within a polymer matrix, and respective simulation snapshots (b) show nanoparticles that did not participate in the percolation network, and respective simulation snapshots (c) show nanoparticles that participated in the percolation network. Referring to FIGS. 3 and 4, it can be seen that the amount of nanoparticles participating in the percolation network (snapshot (c)) was considerably present even when the nanofiber was stretched at an elongation rate of 0.4 in comparison with the nanofiber that did not elongate.

FIG. 5 is a graph illustrating results obtained by simulating a ratio of electrical conductivity to an elongation rate of a polymer nanofiber in which one-dimensional conductive nanoparticles are distributed. The electrical conductivity ratio is the ratio of electrical conductivity at a certain elongation rate to the electrical conductivity at an elongation rate of 0. Referring to FIG. 5, the electrical conductivity decreased from about 1 to about 0.7 when the elongation rate was increased from about 0 to about 0.2. Namely, when the nanofiber was elongated up to about 20%, it was confirmed that about 70% of the initial electrical conductivity was maintained by maintaining a stable percolation network.

### COMPARATIVE EXAMPLE 1

With the exception that zero-dimensional conductive particles having the same weight as the one-dimensional conductive particles of Example 1 were used instead of the one-dimensional conductive particles of Example 1, formation of a percolation network and the electrical conductivity depending on the elongation rate were simulated in the same manner as in Example 1.

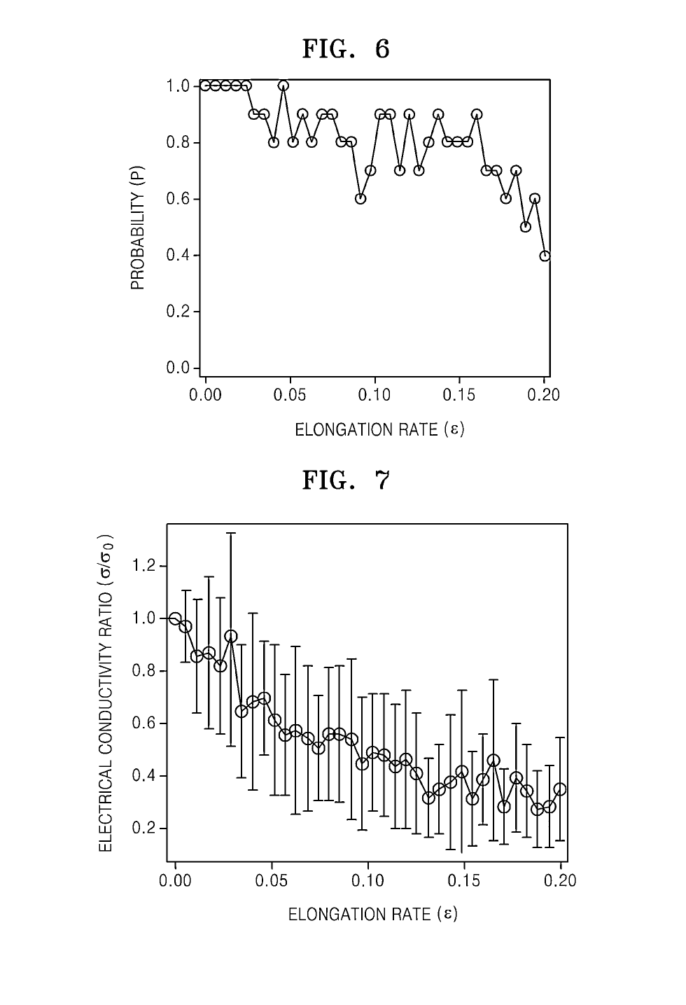

FIG. 6 is a graph illustrating results obtained by simulating the probability of a percolation network being maintained depending on an elongation rate of a polymer nanofiber in which zero-dimensional conductive nanoparticles are distributed. FIG. 7 is a graph illustrating results obtained by simulating a ratio of electrical conductivity to an elongation rate of a polymer nanofiber in which zero-dimensional conductive nanoparticles are distributed.

Referring to FIGS. 6 and 7, in the case of Comparative Example 1, the probability of maintaining the percolation network decreased from about 1 to about 0.4, and the ratio of electrical conductivity was decreased from about 1 to about 0.3 when the elongation rate was increased from about 0 to about 0.2. Accordingly, as the probability of maintaining the percolation network decreases, the ratio of the electrical conductivity also decreases.

In comparison with Comparative Example 1, the ratio of electrical conductivity in Example 1 was more than twice as large at an identical elongation rate of 0.2. Therefore, it can be seen that a nanofiber including one-dimensional particles may maintain electrical conductivity over a greater range of elongation rates as compared to a nanofiber including zero-dimensional particles.

### EXPERIMENTAL EXAMPLE 1

A stretchable conductive nanofiber composition having 0.1 wt % of carbon nanotubes was manufactured by dissolving both 3 g of a polyurethane (PU) polymer and 0.003 g of a multi-walled carbon nanotube having a diameter of about 10 nm and a length of about 5 μm in 10 ml of a DMF solvent,. A stretchable conductive nanofiber was produced by electospinning the composition under the conditions of a nozzle applied voltage of 10 kV, and a solution supply rate of 1 ml/hr.

### EXPERIMENTAL EXAMPLE 2

Except for the fact that the content of carbon nanotubes was 1 wt % instead of 0.1 wt %, a stretchable conductive nanofiber composition was produced in the same manner as in Experimental Example 1.

### EXPERIMENTAL EXAMPLE 3

Except for the fact that the content of carbon nanotubes was 5 wt % instead of 0.1 wt %, a stretchable conductive nanofiber composition was produced in the same manner as in Experimental Example 1.

### EXPERIMENTAL EXAMPLE 4

Except for the fact that carbon nanotubes were not added, a stretchable conductive nanofiber composition was produced in the same manner as in Experimental Example 1.

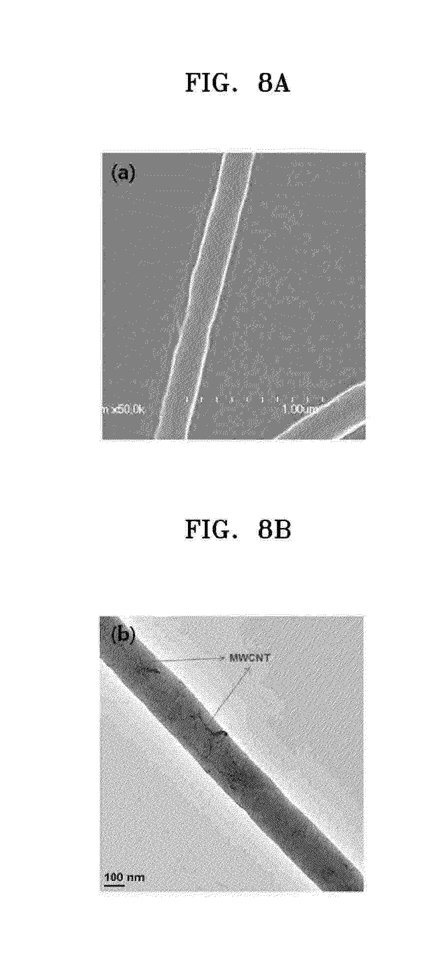

FIGS. 8A and 8B respectively show an SEM image and a TEM image of a PU nanofiber including a multi-walled carbon nanotube, as produced in Example 1. It may be confirmed that the nanofiber in FIGS. 8A and 8B has a diameter in the range of from about 150 nm to about 200 nm, and that carbon nanotubes within the nanofiber are oriented closely to an axis of the nanofiber.

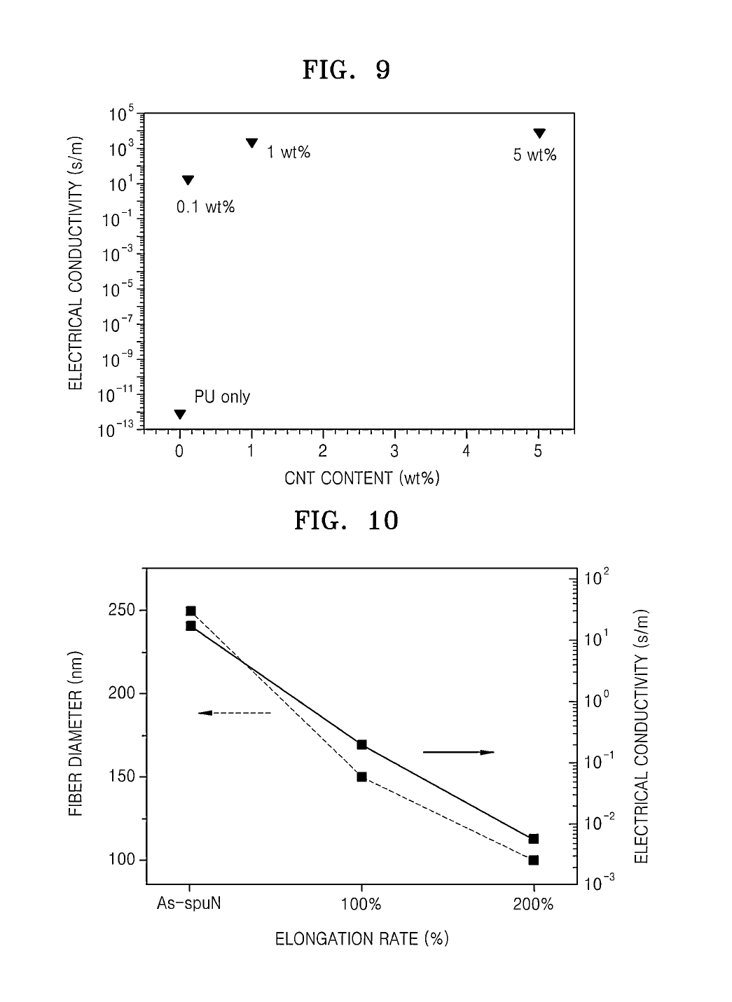

FIG. 9 is a graph illustrating results obtained by measuring electrical conductivity depending on the carbon nanotube (CNT) content within a polyurethane nanofiber. The electrical conductivity of the nanofibers obtained from Experimental Examples 1 to 4 was measured by transferring the nanofiber to the top of a gold electrode patterned on a silicon wafer and making a probe contact the gold electrode. Referring to FIG. 9, the electrical conductivity of the carbon nanotube shows a saturated curve. In FIG. 9, when a content of carbon nanotubes was 0 wt %, the electrical conductivity was 10⁻¹² S/m, but when the content of carbon nanotubes was 0.1 wt %, the electrical conductivity sharply increased to 10¹ S/m. After that, when the content of carbon nanotubes was 1 wt % and 5 wt %, the electrical conductivity increased to 10³ S/m and 10⁴ S/m, respectively, to accordingly show the saturated value of the electrical conductivity. From the graph in FIG. 9, it can be seen that a percolation threshold may be about 0.1 wt %. The percolation threshold of about 0.1 wt % was smaller than the expected percolation threshold (of about 0.5 wt %), and was a much smaller value than the percolation threshold (of about 2 wt % to about 10 wt %) of a conventional stretchable conductive nanofiber composition.

FIG. 10 is a graph showing results obtained by measuring changes in a diameter of a nanofiber and in electrical conductivity thereof depending on an elongation rate of a polyurethane nanofiber that includes 0.1 wt % of carbon nanotubes. From the graph in FIG. 10, it can be seen that the result of a ratio of electrical conductivity to an elongation rate obtained from the simulation in Example 1 was similar to or congruous with the result of the actual experiment.

It should be understood that the exemplary embodiments described herein should be considered to be descriptive only, and non-limiting. Descriptions of features or aspects within each embodiment should typically be considered as being available for other similar features or aspects of other embodiments.

What is claimed is:

1. A stretchable conductive nanofiber comprising:
a polymer nanofiber; and
one-dimensional conductive nanoparticles that form a percolation network within the polymer nanofiber, and are oriented at an angle in a range of from about 0° to about 45° with a respect to an axis of the polymer nanofiber.

2. The stretchable conductive nanofiber according to claim 1, wherein the polymer nanofiber comprises polyurethane (PU), polyvinyl alcohol (PVA), polyethylene oxide (PEO), nylon, polyacrylonitrile (PAN), polydimethylsiloxane (PDMS), low-density polyethylene (LDPE), polymethyl methacrylate (PMMA), or a mixture thereof.

3. The stretchable conductive nanofiber according to claim 1, wherein the polymer nanofiber has a diameter in a range of from about 50 nm to about 1 μm.

4. The stretchable conductive nanofiber according to claim 1, wherein the one-dimensional conductive particles comprise a carbon-based material, an inorganic material, or a mixture thereof.

5. The stretchable conductive nanofiber according to claim 4, wherein the carbon-based material comprises a carbon nanotube or a carbon nanofiber.

6. The stretchable conductive nanofiber according to claim 5, wherein the carbon nanotube is selected from the group consisting of a single-walled nanotube (SWNT), a double-walled nanotube (DWNT), and a multi-walled nanotube (MWNT).

7. The stretchable conductive nanofiber according to claim 4, wherein the inorganic material comprises a metal nanowire or a metal nanorod.

8. The stretchable conductive nanofiber according to claim 7, wherein the metal nanowire or the metal nanorod comprises gold, platinum, silver, copper, tungsten, nickel, tin, zinc, molybdenum, or an alloy thereof.

9. The stretchable conductive nanofiber according to claim 1, wherein the one-dimensional conductive nanoparticles have a diameter in a range of from about 1 nm to about 100 nm.

10. The stretchable conductive nanofiber according to claim 1, wherein the one-dimensional conductive nanoparticles have a length in a range of from about 100 nm to about 10,000 nm.

11. The stretchable conductive nanofiber according to claim 1, wherein the one-dimensional conductive nanoparticles have an aspect ratio in a range of from about 10 to about 1,000.

12. The stretchable conductive nanofiber according to claim 1, wherein the one-dimensional conductive nanoparticles comprise from about 0.1 parts by weight to about 5 parts by weight based on 100 parts by weight of a total weight of the stretchable conductive nanofiber.

13. A method of producing a stretchable conductive nanofiber, the method comprising:
forming a composition by dissolving both one-dimensional conductive nanoparticles and a polymer in a solvent; and
electrospinning the composition so that the one-dimensional conductive nanoparticles form a percolation network within the polymer nanofiber and are oriented at an angle in a range of from about 0° to about 45° with a respect to an axis of the polymer nanofiber.

14. The method of claim 13, wherein the polymer nanofiber comprises polyurethane (PU), polyvinyl alcohol (PVA), polyethylene oxide (PEO), nylon, polyacrylonitrile (PAN), polydimethylsiloxane (PDMS), low-density polyethylene (LDPE), polymethyl methacrylate (PMMA), or a mixture thereof.

15. The method of claim 13, wherein the solvent comprises dimethylformaldehyde (DMF), tetrahydrofuran (THF), chloroform, chlorobenzene, toluene, dimethyl sulfoxide (DMSO), N-methylpyrrolidone (NMF), water, acetone, ethanol, and a mixture of two or more thereof.

16. The method of claim 13, wherein the polymer nanofiber has a diameter in a range of from about 50 nm to about 1 μm.

17. The method of claim 13, wherein the one-dimensional conductive nanoparticles comprise a single-walled carbon nanotube, a double-walled carbon nanotube, a multi-walled carbon nanotube, a metal nanowire, or a metal nanorod.

18. The method of claim 13, wherein the one-dimensional conductive nanoparticles have a diameter in the range of from about 1 nm to about 100 nm.

19. The method of claim 13, wherein the one-dimensional conductive nanoparticles have a length in the range of from about 100 nm to about 10,000 nm.

20. The method of claim 13, wherein the one-dimensional conductive nanoparticles are present in an amount of from about 0.1 parts by weight to about 5 parts by weight based on 100 parts by weight of a total weight of the stretchable conductive nanofiber.

21. A method of forming a percolation network, the method comprising:
orienting one-dimensional conductive nanoparticles within a polymer nanofiber at an angle of from about 0° to about 45°, as measured with respect to an axis of the polymer nanofiber.

22. The method of forming a percolation network of claim 21, wherein the polymer nanofiber has a diameter in a range of from about 50 nm to about 1 μm.

23. The method of forming a percolation network of claim 21, wherein the one-dimensional conductive nanoparticles comprise a single-walled nanotube, a double-walled nanotube, or a multi-walled nanotube.

24. The method of forming a percolation network of claim 21, wherein the one-dimensional conductive nanoparticles comprise a metal nanowire or metal nanorod comprising gold, platinum, silver, copper, tungsten, nickel, tin, zinc, molybdenum, or an alloy thereof.

25. The method of forming a percolation network of claim 21, wherein the one-dimensional conductive nanoparticles have an aspect ratio in a range of from about 10 to about 10,000.
